(19) United States
(12) Patent Application Publication
(10) Pub. No.: US 2011/0313912 A1
(43) Pub. Date: Dec. 22, 2011

(54) DATA STRATIFICATION AND CORRESPONDENCE GENERATION SYSTEM

(75) Inventors: Michael Teutsch, Hudson, OH (US); Carl Trownson, JR., Streetsboro, OH (US); Raymond P. Dalessandro, Stow, OH (US); Eric P. Svonavec, Richmond Heights, OH (US); James M. Balint, Stow, OH (US); Stephen E. Smith, Rolla, MO (US)

(73) Assignee: ETACTICS, LLC, Stow, OH (US)

(21) Appl. No.: 13/157,019

(22) Filed: Jun. 9, 2011

Related U.S. Application Data
(60) Provisional application No. 61/356,174, filed on Jun. 18, 2010.

(51) Int. Cl. G06Q 40/00; G06Q 50/00

(52) U.S. Cl. 705/38

(57) ABSTRACT

Some embodiments may relate to a computerized data stratification and correspondence generation process. For instance, in some embodiments a processor may retrieve a guarantor's income predictor, number of dependents, Open Auto, Mortgage, Open To Buy, HCPI, Derogatories, Open To Buy, and Total Charges from a plurality of data sources, and the processor may take the sum of the guarantor's HCPI and HCPI adjustment amounts. Such a calculation may result in a payment probability indicator. In some embodiments the indicator may correspond to one or more debt collection methodologies.

This application claims priority to U.S. provisional patent application No. 61/356,174 filed on Jun. 18, 2010 and now pending, which is incorporated herein by reference in its entirety.

### I. BACKGROUND OF THE INVENTION

A. Field of Invention

Some embodiments of the present invention generally relate to health care billing and collections systems and related methods.

B. Description of the Related Art

Health care billing and collection methodologies are known in the art; however, they suffer from a number of deficiencies. Health care providers often dedicate substantial resources to the collection of debts that are not collectable or that could be more efficiently collected by applying methodologies that are more appropriate to the debtor or guarantor of the debt. Furthermore, many debtors may not be aware that they are eligible for financial assistance and therefore continue to struggle to pay a bill that they ultimately cannot afford. Indeed, many guarantors may simply give up or declare bankruptcy when more suitable means are available for dealing with the debt.

What is needed is a system and/or method for classifying, i.e. stratifying, guarantors according to financial parameters to identify those who are eligible for charitable write-offs, or government assistance, etc. Embodiments of the present invention may provide one or more advantages over the prior art.

### II. SUMMARY OF THE INVENTION

Some embodiments may relate to a computerized data stratification and correspondence generation process, comprising the steps of: loading a guarantor's health care billing data including at least a Total Charges parameter, a number of the guarantor's dependents, and at least one identifying datum into a random access memory; executing a new accounts subroutine, wherein a processor searches a guarantor database using the at least one identifying datum for a record of the guarantor and determines whether the guarantor is a new or existing guarantor; executing a credit data request subroutine, wherein the processor retrieves credit bureau data of the guarantor, the credit bureau data including an income predictor, an Open Auto parameter, a Mortgage parameter, an Open To Buy parameter, an HCPI, and a Derogatories parameter, and the processor loading the credit bureau data into a random access memory; executing a potential eligibility subroutine, wherein the processor relates a combination of the guarantor's income predictor and number of dependents to a percentage write-off, the potential eligibility subroutine returning a percentage write-off; executing a disqualifier subroutine, wherein the processor compares the guarantor's Open Auto, Open To Buy and Mortgage parameters to predetermined maxima, the disqualifier subroutine returning a determination of whether or not the guarantor has exceeded one or more of the predetermined maxima; executing a payment probability indicator subroutine, wherein the processor calculates a payment probability indicator by taking the sum of the guarantor's HCPI, and HCPI adjustment amounts related to the guarantor's Derogatories, Open To Buy and Total Charges parameters, the payment probability indicator subroutine returning the payment probability indicator; and executing a collection subroutine, wherein the processor selects a collections protocol according to the payment probability indicator and a debt magnitude of the guarantor, the collections subroutine issuing at least a first billing statement and cover letter according to the selected protocol.

In some embodiments the step of loading a guarantor's health care billing data further comprises receiving the health care billing data from an external accounts receivable database.

In some embodiments the step of executing a new accounts subroutine further comprises performing an action with the healthcare billing data selected from one or more of updating the corresponding guarantor database record, correcting the corresponding guarantor database record, adding missing guarantor data to the corresponding guarantor database record, or creating a new guarantor database record for the guarantor if none already exists in the guarantor database.

In some embodiments the step of executing a credit data request subroutine further comprises retrieving the credit bureau data either from a remote credit bureau database or from a local database.

Some embodiments further comprise manually adding or updating guarantor credit data.

In some embodiments the income predictor comprises the sum of the guarantor's income predictor and the income predictor of the guarantor's spouse if any.

In some embodiments the step of executing a potential eligibility subroutine further comprises providing a look-up table relating one or more combinations of income predictor and number of dependents to percentage write-offs, and the processor matching the guarantor's income predictor and number of dependents to a percentage write-off.

In some embodiments the step of executing a disqualifier subroutine includes indicating whether the guarantor is disqualified from write-off eligibility.

Some embodiments further comprise providing a look-up table relating ranges of each of the Derogatories, Open To Buy and Total Charges parameters to corresponding HCPI adjustment amounts.

In some embodiments the processor assigns the payment probability indicator to a payment risk category, and the processor assigns a debt of the guarantor to a debt magnitude category, and the processor selects a collections protocol from a set of predetermined collections protocols corresponding to a combination of the of the payment risk category and the debt magnitude category, the collections subroutine returning the selected collections protocol, and issuing at least a first billing statement and cover letter according to the selected protocol.

In some embodiments the payment probability indicator is manually determined and entered into the system.

Some embodiments further comprise assessing the guarantor's eligibility for Medicaid assistance, and billing Medicaid for the guarantor's debt.

Some embodiments may relate to a computerized process for determining a payment probability indicator, comprising the steps of: using a processor to retrieve a guarantor's income predictor, number of dependents, Open Auto, Mortgage, Open To Buy, HCPI, Derogatories, and Total Charges from a plurality of data sources; the processor taking the sum of the guarantor's HCPI and HCPI adjustment amounts related to the guarantor's Derogatories, Open To Buy and Total Charges parameters, the payment probability indicator subroutine returning the payment probability indicator.

In some embodiments the income predictor comprises the sum of the guarantor's income predictor and the income predictor of the guarantor's spouse.

Some embodiments further comprise providing a look-up table relating ranges of each of the Derogatories, Open To Buy and Total Charges parameters to corresponding HCPI adjustment amounts.

Some embodiments may relate to a computerized data stratification and correspondence generation process, comprising the steps of: loading a guarantor's health care billing data including a number of the guarantor's dependents, a Total Charges parameter, and at least one identifying datum into a random access memory; executing a new accounts subroutine, wherein a processor searches a guarantor database using the at least one identifying datum for a record of the guarantor and performing an action with the healthcare billing data selected from one or more of updating the corresponding guarantor database record, correcting the corresponding guarantor database record, adding missing guarantor data to the corresponding guarantor database record, or creating a new guarantor database record for the guarantor if none already exists in the guarantor database; executing a credit bureau data request subroutine, wherein the processor retrieves credit bureau data of the guarantor from a remote credit bureau database, the credit bureau data including an income predictor, an Open Auto parameter, a Mortgage parameter, an Open To Buy parameter, an HCPI, and a Derogatories parameter, and the processor loading the credit bureau data into a random access memory; executing a potential eligibility subroutine, wherein the processor relates a combination of the guarantor's income predictor and number of dependents to a percentage write-off, the potential eligibility subroutine returning a percentage write-off; executing a disqualifier subroutine, wherein the processor compares the guarantor's Open Auto, Open To Buy and Mortgage parameters to predetermined maxima, the disqualifier subroutine returning a determination of whether the guarantor is disqualified from eligibility for a write-off for exceeding one or more of the predetermined maxima; executing a payment probability indicator subroutine, wherein the processor relates each of the Derogatories, Open To Buy and Total Charges parameters to corresponding HCPI adjustment amounts, adds the corresponding HCPI adjustment amounts to the HCPI, and returns the corresponding payment probability indicator; and executing a collection subroutine, wherein the processor assigns the payment probability indictor to a payment risk category, and the processor assigns a debt of the guarantor to a debt magnitude category, and the processor selects a collections protocol from a set of predetermined collections protocols corresponding to a combination of the of the payment risk category and the debt magnitude category, the collections subroutine returning the selected collections protocol, and issuing at least a first billing statement and cover letter according to the selected protocol.

Some embodiments further comprise manually adding or updating guarantor credit data.

In some embodiments the payment probability indicator is manually determined and entered into the system.

Some embodiments further comprise determining whether the guarantor is eligible for Medicaid assistance, and billing Medicaid for the guarantor's debt.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a flow chart schematically showing an embodiment of the present invention.

FIG. 2 is a flow chart schematically showing a communications and/or bill collections model of the present invention.

### IV. DETAILED DESCRIPTION OF THE INVENTION

According to an embodiment, a guarantor data stratification and correspondence generation system comprises a means for discriminating between collectable and uncollectable accounts receivable. Some embodiments may benefit a healthcare provider by automating the process of determining whether a guarantor qualifies for charitable write-off of debt. The system can then apply appropriate predetermined collection and communication methodologies according to the probability of successfully collecting the debt. Some embodiments may include methods for converting guarantor billing and credit bureau data into collections correspondence for the purpose of obtaining payment of a debt. Further, some embodiments may include devices or systems of devices for converting guarantor billing and credit bureau data into collections correspondence for the purpose of obtaining payment of a debt. As used herein the term system includes guarantor data stratification systems, correspondence generation systems, methods and/or devices for data stratification and/or correspondence generation or any combination thereof.

Guarantor billing statements and/or accounts receivable data files that are consistent with systems and methods of the present invention can comprise guarantor information including, without limitation, given name, surname, middle initial, residential address, date of birth, social security number, telephone number, Total Charges, number of and dependents, as well as other data. Table 1 is a map of a data file containing the foregoing information. Such a data file can comprise a database record of an embodiment, or can comprise data from which a database record is created. Table 1 includes the start and stop position in bytes of every data field and the length of each data field in bytes. One of skill in the art will recognize that any of a variety of data and data organization schemes can be functional and/or appropriate and therefore within the scope of the present invention.

TABLE 1

| Start | Ending | | | |
|---|---|---|---|---|
| Position | Position | Length | Description | Attr. # |
| 1 | 16 | 16 | Internal use-leave blank | |
| 17 | 17 | 1 | Record Type (1-Personal) | |
| 18 | 57 | 40 | Personal: First Name Middle Initial | |
| | | | Last Name | |
| 58 | 107 | 50 | Mailing Address | |
| 108 | 129 | 22 | City | |
| 130 | 131 | 2 | State Abbreviation | |
| 132 | 136 | 5 | Zip code | |
| 137 | 140 | 4 | Zip + 4 | |
| 141 | 150 | 10 | Telephone Number | |
| 151 | 178 | 28 | Filler 2 | |
| 179 | 184 | 6 | Filler 3 | |
| 185 | 193 | 9 | SSN (Optional) | |
| 194 | 201 | 8 | Date of Birth (DDMMYYYY)- | |
| | | | Optional | |
| 202 | 224 | 23 | Filler 4 | |

Credit bureau data consistent with embodiments of the present invention can include, without limitation, social security number, SafeScan code, phone number, a first former address, a second former address, current address, employer name, employer city, employer state, a deceased flag, unused credit (e.g. “Open To Buy”) including bankcard, home equity, personal finance, number of mortgages, number of accounts in collection with a balance greater than zero, aggregate collection balance, presence of bankruptcy trade, presence of bankruptcy public record, most recent bankruptcy public record disposition date, date filed on bankruptcy record, court number of the most recent bankruptcy public record filing, type of the most recent bankruptcy public record filing, filer of the most recent bankruptcy public record filing, intent code most recent bankruptcy public record filing, consumer age, number of collections with a balance of zero excluding medical collections, number of medical accounts in collections with a zero balance, number of medical accounts in collection with a balance greater than or equal to one dollar, aggregate balance of medical accounts in collection with a balance greater than zero, the number of accounts in collection with a balance greater than zero but excluding medical accounts, aggregate balance of accounts in collection excluding medical accounts, aggregate balance of home equity loans, the highest balance on any mortgage installment loan, the credit limit on the highest balance mortgage installment account, number of auto loans, number of auto leases, number of open auto loans, number of open auto leases, aggregate credit limit on all open auto loans, aggregate credit limit on all open auto leases, aggregate balance on all auto loans, aggregate balance on all auto leases, verified social security number, number of judgments of public record within the last 12 months, number of judgments of public record within the last 24 months, number of judgments of public record within the last 36 months, number of judgments of public record within the last 48 months, aggregate amount of judgments of public record, number of unreleased tax liens of public record in the last 12 months, number of unreleased tax liens of public record in the last 24 months, number of unreleased tax liens of public record in the last 36 months, number of unreleased tax liens of public record in the last 48 months, the aggregate amount of unreleased tax liens, aggregate amount of monthly payments on debt accounts, date of birth, Equifax recovery score, Equifax recovery index score, Equifax risk score 3.0 odds, advanced energy risk model score, TELCO 98 score, advanced wireless risk model score, income predictor 2.0, risk predictor, healthcare payment predictor, BNI 3.0 including bankruptcy, personal income model, FACTA fraud alert indicator, FACTA alert code indicator, FACTA address discrepancy indicator, and Fact ACT consumer data.

Table 2 is a data file map of the foregoing information showing the start and stop positions in bytes of each data field, as well as the length in bytes of each data field. The first 224 bytes are occupied by guarantor data, for instance, as set forth in Table 1.

TABLE 2

| Start | Ending | | | |
|---|---|---|---|---|
| Position | Position | Length | Description | Attr. # |
| 1 | 224 | | Table 1 Data | |
| 225 | 235 | 11 | Equifax Sequence Number | |
| 236 | 244 | 9 | Social Security Number (Equifax Main Database) | |
| 245 | 245 | 1 | Safescan Code | |
| 246 | 255 | 10 | Phone Number | Attr #53 |
| 256 | 337 | 82 | Former MDB Address 1 | Attr #46 |
| 338 | 419 | 82 | Former MDB Address 2 | Attr #47 |
| 420 | 501 | 82 | Current MDB Address | Attr #48 |
| 502 | 546 | 45 | MDB Employment (Name of Company) | Attr #49 |
| 547 | 554 | 8 | MDB Employment (City) | Attr #50 |
| 555 | 556 | 2 | MDB Employment (State) | Attr #51 |
| 557 | 557 | 1 | Deceased Flag (Y or N) | Attr #1 |
| 558 | 565 | 8 | Open to Buy Bankcard (excludes closed trades) | Attr #2 |
| 566 | 573 | 8 | Open to Buy Home Equity (excludes closed trades) | Attr #3 |
| 574 | 581 | 8 | Open to Buy Personal Finance (excludes closed trades) | Attr #4 |
| 582 | 583 | 2 | # of Mortgage Trade-Installment | Attr #5 |
| 584 | 585 | 2 | # of Collection with Bal >$0 | Attr #6 |
| 586 | 593 | 8 | Agg Collection Balance | Attr #7 |
| 594 | 594 | 1 | Presence of Bankruptcy Trade | Attr #8 |
| 595 | 595 | 1 | Presence of Bankruptcy Public Record | Attr #9 |
| 596 | 601 | 6 | Most Recent Bankruptcy Public Record Disposition Date | Attr #10 |
| 602 | 607 | 6 | Date Filed on Bankruptcy Record | Attr #11 |
| 608 | 617 | 10 | Court Number of the most recent Bankruptcy Public Record Filing | Attr #12 |
| 618 | 618 | 1 | Type of the most recent Bankruptcy Public Record Filing | Attr #13 |
| 619 | 619 | 1 | Filer of the most recent Bankruptcy Public Record Filing | Attr #14 |
| 620 | 620 | 1 | Intent Code most recent Bankruptcy Public Record Filing | Attr #15 |
| 621 | 623 | 3 | Consumer Age | Attr #16 |
| 624 | 625 | 2 | # of Collection with Bal = 0 exclude Collection Medical | Attr #17 |
| 626 | 627 | 2 | # of Collection Medical with Bal = 0 | Attr #18 |
| 628 | 629 | 2 | # of Collection Medical with Bal >= 1 | Attr #19 |
| 630 | 637 | 8 | Agg Balance of Collection-Medical Bal > 0 | Attr #20 |
| 638 | 639 | 2 | # of Collection Bal > 0 exclude Collection Medical | Attr #21 |
| 640 | 647 | 8 | Agg Collection Balance exclude Collection Medical | Attr #22 |
| 648 | 655 | 8 | Agg Balance of Home Equity Trade | Attr #23 |
| 656 | 663 | 8 | Highest Balance on Mortgage Trade-Installment | Attr #24 |
| 664 | 671 | 8 | High Credit/Credit Limit Highest Bal Mortgage Trade Installment | Attr #25 |
| 672 | 673 | 2 | # of Auto Trade Loan | Attr #26 |
| 674 | 675 | 2 | # of Auto Trade Lease | Attr #27 |
| 676 | 677 | 2 | # of Open Auto Loan | Attr #28 |
| 678 | 679 | 2 | # of Open Auto Lease | Attr #29 |
| 680 | 687 | 8 | Agg High Credit/Credit Limit Open Auto Loan | Attr #30 |
| 688 | 695 | 8 | Agg High Credit/Credit Limit Open Auto Lease | Attr #31 |
| 696 | 703 | 8 | Agg Balance Auto Loan | Attr #32 |
| 704 | 711 | 8 | Agg Balance Auto Lease | Attr #33 |
| 712 | 712 | 1 | Social Security Number Verified | Attr #34 |
| 713 | 714 | 2 | # of Judgment Public Record within 12 mos. | Attr #35 |
| 715 | 716 | 2 | # of Judgment Public Record within 24 mos. | Attr #36 |
| 717 | 718 | 2 | # of Judgment Public Record within 36 mos. | Attr #37 |
| 719 | 720 | 2 | # of Judgment Public Record within 48 mos. | Attr #38 |
| 721 | 728 | 8 | Agg Judgment Public Record Amount | Attr #39 |
| 729 | 730 | 2 | # of Tax Lien Unreleased Public Record within 12 mos. | Attr #40 |
| 731 | 732 | 2 | # of Tax Lien Unreleased Public Record within 24 mos. | Attr #41 |
| 733 | 734 | 2 | # of Tax Lien Unreleased Public Record within 36 mos. | Attr #42 |
| 735 | 736 | 2 | # of Tax Lien Unreleased Public Record within 48 mos. | Attr #43 |
| 737 | 744 | 8 | Agg Tax Lien Unreleased Public Record Amount | Attr #44 |
| 745 | 752 | 8 | Agg Monthly Payment Amount Open Trade | Attr #45 |
| 753 | 760 | 8 | Date of Birth (MMDDYYYY) | Attr #52 |
| 761 | 790 | 30 | Filler | |
| 791 | 795 | 5 | Equifax Recovery Score (psps0785) | Attr #54 |
| 796 | 800 | 5 | Equifax Recovery Index Score (psps0779) | Attr #55 |
| 801 | 805 | 5 | Equifax Risk Score 3.0 Odds (psps1174) | Attr #56 |
| 806 | 810 | 5 | Advanced Energy Risk Model Score (psps1025) | Attr #57 |
| 811 | 815 | 5 | TELCO 98 Score (psps0337) | Attr #58 |
| 816 | 820 | 5 | Advanced Wireless Risk Model Score (psps0982) | Attr #59 |
| 821 | 825 | 5 | Income Predictor 2.0 (psps1070) | Attr #60 |
| 826 | 830 | 5 | Risk Predictor (psps0758) | Attr #61 |
| 831 | 835 | 5 | Healthcare Payment Predictor (psps2316) | Attr #62 |
| 836 | 840 | 5 | BNI 3.0 Include Bankruptcy (psps1084) | Attr #63 |
| 841 | 845 | 5 | Personal Income Model (psps2338) | Attr #64 |
| 846 | 880 | 35 | Filler | |
| 881 | 881 | 1 | FACTA Fraud Alert Indicator (V, X, N, Q, W, T, R) | |
| 882 | 882 | 1 | FACTA Alert Code Indicator (Y/N) | |
| 883 | 883 | 1 | FACTA Address Discrepancy Indicator (Y/N) | |
| 884 | 1423 | 540 | Fact ACT Consumer Data | |

According to some embodiments credit bureau data, such as that which is set forth in Table 2, can be first loaded into an embodiment at or about the time when a new guarantor record is created. Some embodiments also may allow for the credit bureau data to be updated from time to time in order to account for changes in the guarantor's credit bureau records. Furthermore, in some embodiments the data file can be manually edited to provide a means for correcting inaccuracies.

In some embodiments, a data stratification and correspondence generation system includes a means for receiving and recording accounts receivable data in a database. Embodiments can also include a means for comparing the accounts receivable data to guarantor data recorded in a database and determine whether a record of the guarantor is already in the database or whether the guarantor is new. Embodiments can further include a means for updating the guarantor's balance if a record of the guarantor is already in the database, i.e. the guarantor is not new. Additionally, embodiments can include a means for requesting credit bureau data related to the guarantor. For example, if the guarantor is found to be new then some embodiments can request the guarantor's credit bureau data from a credit bureau, and receive and record such data, or the lack thereof, in a database.

In some embodiments, data stratification and correspondence generation system can further comprise a means for determining whether the guarantor falls into a general class of guarantors that may be eligible for charitable write-off of a debt. As used herein the term potentially eligible guarantors includes the foregoing general class of guarantors. According to such embodiments, if the system determines that the guarantor may be eligible for charitable write-off or assistance, then the system can apply a means for determining whether the guarantor is in fact eligible for charitable write-off or assistance. In some embodiments, the steps of determining guarantor's general class and specific eligibility can be combined into a single step and can be determined by a single means.

In some embodiments, a process for determining whether the guarantor is a potentially eligible guarantor can include the steps of retrieving particular credit bureau parameters from a remote credit bureau database, or from a database of the embodiment if the data has already been downloaded from a credit bureau and recorded. Such parameters can include the guarantor's income predictor, and the income predictor of the guarantor's spouse if any. In some embodiments the income predictors of the guarantor and the guarantor's spouse can be combined and the sum used as the income predictor for determining eligibility. As used herein the term income predictor includes (1) a guarantor's estimated income as provided by a credit bureau, (2) the sum of a guarantor's income predictor, and that of the guarantor's spouse, (3) the income of a guarantor as verified by the creditor, (4) the sum of a guarantor's income and that of the guarantor's spouse as verified by the creditor, and (5) any of the foregoing items 1 through 4 divided by 1000.

According to some embodiments a guarantor is a potentially eligible guarantor provided that the guarantor's income predictor is sufficiently low considering that guarantor's number of dependents. Thus, the guarantor's income predictor and number of dependents determine (1) whether the guarantor is potentially eligible for a write-off, and (2) the percentage write-off for which the guarantor is potentially eligible provided all other restrictions are met. Some embodiments can include a look-up table relating income predictor and number of dependents to percentage write-off.

An example of such a table is shown in Table 3 for illustrative purposes only, and is in no way intended to be limiting. For instance, according to Table 3, a guarantor's debt can be completely written off if the guarantor's income predictor parameter is less than or equal to 150% of the federal poverty guideline. However, the specific percentage of the federal poverty guideline need not be 150% and can be assigned as needed by a user of the system to suit the business needs of the particular creditor. Furthermore, while Table 3 indicates a series of three percentage write-off tiers, other embodiments need not use such a system. For instance, a look-up table could be structured differently with different tiers, or an equation could be used to define a continuous range of write-off percentages according to a predetermined linear or nonlinear formula.

TABLE 3

| | | % of Federal | Write |
|---|---|---|---|
| No. of Dependents | Max Income | Poverty Guideline | off Percentage |
| 1 | $16,245 | 150% | 100% |
| 2 | $21,855 | 150% | 100% |
| 3 | $27,465 | 150% | 100% |
| 4 | $33,075 | 150% | 100% |
| 5 | $38,685 | 150% | 100% |
| 6 | $44,295 | 150% | 100% |
| 7 | $49,905 | 150% | 100% |
| 8 | $55,515 | 150% | 100% |
| 9 | $61,125 | 150% | 100% |
| 10 | $66,735 | 150% | 100% |
| 1 | $18,086 | 167% | 50% |
| 2 | $24,331 | 167% | 50% |
| 3 | $30,577 | 167% | 50% |
| 4 | $36,823 | 167% | 50% |
| 5 | $43,069 | 167% | 50% |
| 6 | $49,315 | 167% | 50% |
| 7 | $55,560 | 167% | 50% |
| 8 | $61,806 | 167% | 50% |
| 9 | $68,052 | 167% | 50% |
| 10 | $74,298 | 167% | 50% |
| 1 | $20,035 | 185% | 25% |
| 2 | $26,954 | 185% | 25% |
| 3 | $33,873 | 185% | 25% |
| 4 | $40,792 | 185% | 25% |
| 5 | $47,711 | 185% | 25% |
| 6 | $54,630 | 185% | 25% |
| 7 | $61,549 | 185% | 25% |
| 8 | $68,468 | 185% | 25% |
| 9 | $75,387 | 185% | 25% |
| 10 | $82,306 | 185% | 25% |

According to some embodiments, if a system determines that the guarantor qualifies as a potentially eligible guarantor then in some embodiments the system can check for disqualifying factors. Such a check can begin, for instance, by retrieving several variables from a remote credit bureau database, or from a database of the system if such data has already been downloaded and recorded. In one embodiment these parameters include the Open Auto parameter, the Open to Buy parameter, and the Mortgage parameter. As used herein the term Open Auto includes the aggregate unused credit on a guarantor's auto loan(s). As used herein the term Open To Buy, or Open To Buy Bankcard, includes a guarantor's aggregate available credit. As used herein the term Mortgage includes the highest balance on a mortgage trade on a guarantor's credit record. According to some embodiments, the system can compare the value of each parameter to predetermined maxima, and if any one of these parameters meets or exceeds a predetermined maximum then the guarantor can be disqualified from charitable write-off. Some embodiments enable users of the system to assign and/or reassign maxima as needed.

According to some embodiments, if one or more of the maxima of the parameters for determining a potentially eligible guarantor are exceeded then the guarantor is not eligible for a charitable write-off in any amount regardless of the guarantor's income predictor and number of dependents. Some embodiments next determine an appropriate methodology for collecting the debt from the guarantor, the method being selected from a set of predetermined methodologies. For instance, in some embodiments, a health care payment indicator (i.e. an HCPI) can be adjusted according to several predetermined parameters to define a Payment Probability Indicator (PPI). According to some embodiments the combination of the PPI and the amount of the debt are used to determine the appropriate collection methodology.

In one embodiment, the PPI can be calculated according to Formula 1, where

HCPI is the health care payment indicator score supplied by the credit bureau, and A_{D}, A_{OTB}, and A_{TC} are adjustment amounts related to the Derogatories, Open To Buy and Total Charges parameters respectively. In some embodiments the HCPI may be that of the guarantor, or where the guarantor is married, the higher of the HCPI of the guarantor and that of the guarantor's spouse. According to some embodiments the values of A_{D}, A_{OTB}, and A_{TC} are determined by assigning adjustment amounts to ranges of the Derogatories, Open To Buy and Total Charges parameters. An example of a look-up table illustrating such a relationship according to one embodiment is shown in Table 4.

PPI=HCPI+A_{D}+A_{OTB}+A_{TC} (Formula 1)

TABLE 4

| | | | | | HCPI Ad- |
|---|---|---|---|---|---|
| Adjustment | Factor 1 | Factor 1 | Factor 2 | Factor 2 | justment |
| Type | Min | Max | Min | Max | Amount |
| DEROG | 0 | 1 | N/A | N/A | 50 |
| DEROG | 2 | 5 | N/A | N/A | 0 |
| DEROG | 6 | 12 | N/A | N/A | −25 |
| DEROG | 13 | 19 | N/A | N/A | −50 |
| DEROG | 20 | 999,999 | N/A | N/A | −100 |
| OPENTOBUY | — | 250 | N/A | N/A | −75 |
| OPENTOBUY | 251 | 2,500 | N/A | N/A | 0 |
| OPENTOBUY | 2,501 | 10,000 | N/A | N/A | 25 |
| OPENTOBUY | 10,001 | 25,000 | N/A | N/A | 65 |
| OPENTOBUY | 25,001 | 999,999,999 | N/A | N/A | 100 |
| TOTCHG | — | 500 | 0 | 999,999 | 0 |
| TOTCHG | 501 | 2,500 | 0 | 15 | −100 |
| TOTCHG | 501 | 2,500 | 16 | 30 | −50 |
| TOTCHG | 501 | 2,500 | 31 | 50 | 0 |
| TOTCHG | 501 | 2,500 | 51 | 75 | 0 |
| TOTCHG | 501 | 2,500 | 76 | 999,999 | 0 |
| TOTCHG | 2,501 | 10,000 | 0 | 15 | −150 |
| TOTCHG | 2,501 | 10,000 | 16 | 30 | −100 |
| TOTCHG | 2,501 | 10,000 | 31 | 50 | 0 |
| TOTCHG | 2,501 | 10,000 | 51 | 75 | 0 |
| TOTCHG | 2,501 | 10,000 | 76 | 999,999 | 0 |
| TOTCHG | 10,001 | 25,000 | 0 | 15 | −200 |
| TOTCHG | 10,001 | 25,000 | 16 | 30 | −150 |
| TOTCHG | 10,001 | 25,000 | 31 | 50 | −50 |
| TOTCHG | 10,001 | 25,000 | 51 | 75 | 0 |
| TOTCHG | 10,001 | 25,000 | 76 | 999,999 | 0 |
| TOTCHG | 25,001 | 999,999,999 | 0 | 15 | −200 |
| TOTCHG | 25,001 | 999,999,999 | 16 | 30 | −150 |
| TOTCHG | 25,001 | 999,999,999 | 31 | 50 | −100 |
| TOTCHG | 25,001 | 999,999,999 | 51 | 75 | −50 |
| TOTCHG | 25,001 | 999,999,999 | 76 | 999,999 | 0 |

According to Table 4, the Derogatories parameter is divided into five ranges 0 to 1, 2 to 5, 6 to 12, 13 to 19, and 20 to 999,999. Thus, if the guarantor has a Derogatories score of six then A_{D} is −25, i.e. 25 is subtracted from the HCPI. Similarly, if the guarantor has an Open To Buy score of 5000, the A_{OTB} is 25, i.e. 25 is added to the HCPI. Finally, if the guarantor has a Total Charges score of 600 and an income predictor ×10⁻³ (factor 2) of 60 (i.e. an income predictor of 60,000) then A_{TC} is zero. Accordingly, if the HCPI is 650 and if the A_{D}, A_{OTB}, and A_{TC} scores are equal to the values set forth in this paragraph then a sample PPI calculation would be PPI=650−25+25+0=650.

In some embodiments a PPI can define a range from 0 to an arbitrary upper limit, e.g. 999,999. Furthermore, the PPI may be divided into a set of ranges corresponding to general classes of debtors. For instance, as shown in Table 5 some embodiments can divide the PPI range into 1 to 600 (bad debt), 601 to 775 (low payment probability), 776 to 900 (medium payment probability) and 900 to an upper limit (high payment probability). Thus, the PPI can be assigned to a payment risk category corresponding to a PPI range. In some embodiments, each PPI range can correspond to a predetermined collection methodology. Thus, the system can assign a guarantor to a collection methodology that is appropriate for that guarantor's payment probability. As a result, the creditor can avoid expending excessive resources attempting to collect debts from low probability payers, and focus more resources on those more likely to pay thus increasing profitability.

TABLE 5
PPI Ratings

| Description | MinScore | MaxScore |
|---|---|---|
| Bad Debt | 1 | 600 |
| Low Payment Probability | 601 | 775 |
| Medium Payment Probability | 776 | 900 |
| High Payment Probability | 901 | 999,999 |

Some embodiments include a means for calculating a recommended monthly payment. For instance, an embodiment can include determining a median income in the guarantor's geographic region. The median income can be subtracted from an income predictor to calculate an income difference. A maximum payment factor can be a percentage of the income difference. The sum of the maximum payment factor and an Open to Buy factor can be equal to an annual recommended payment amount, which can be divided by twelve to arrive at a recommended monthly payment amount.

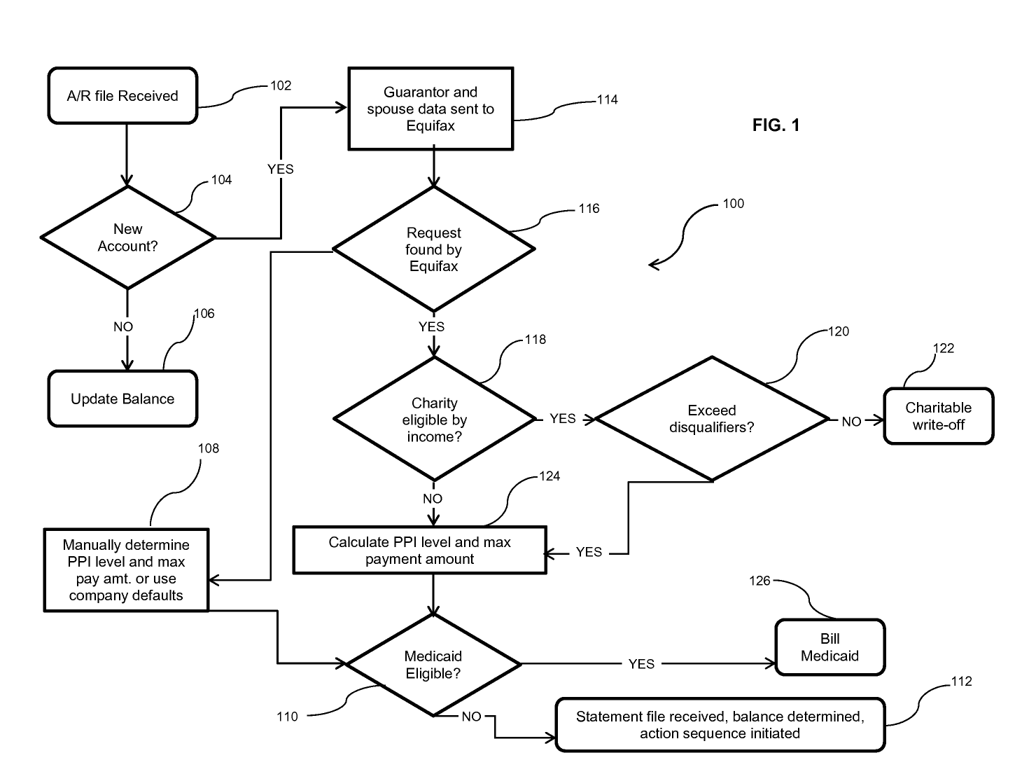

Turning to the drawings, FIG. 1 shows an embodiment 100 comprising a guarantor data stratification system. According to the embodiment 100 of FIG. 1, an electronic accounts receivable data file is entered 102 into the embodiment 100, for instance, by data entry personnel or by electronic communication with an external billing program and/or billing database. The accounts receivable data can be held in volatile memory, and a new accounts subroutine 104 of the embodiment 100 can check the accounts receivable data for one or more identifying data elements such as, without limitation, a social security number, name, or client ID number. As used herein the term subroutine includes components of a larger computer program. Furthermore, although some examples herein refer to specific subroutines it is understood that one or more of these subroutines can be combined or may be inseparable program elements. Such modifications do not depart from the scope of the present invention.

If an identifying data element is found then the new accounts subroutine 104 can search a guarantor database of the embodiment 100 for a record matching the identifying data element(s). If a match is not found then the accounts receivable data corresponds to a new guarantor and the new accounts subroutine 104 can create a new record in the guarantor database containing the new accounts receivable data. Alternatively, if the new accounts subroutine 104 finds a matching guarantor database record then the embodiment 100 can load the record into volatile memory and can use a processor of the embodiment 100 to compare each data field of the new accounts receivable data to the data fields of the existing guarantor database record and enter and/or overwrite data as needed. Accordingly, the new accounts subroutine can fill in empty data fields, update data fields, or correct errors in data fields of the existing guarantor database record. Some embodiments can further comprise a means for alerting a user to data conflicts which the user can resolve manually.

If the embodiment 100 determines that the accounts receivable data 102 represents a new guarantor, then a credit data request subroutine 114 of the embodiment 100 can request credit bureau data from a remote credit bureau database pertaining to the guarantor and the guarantor's spouse if any. A credit data receipt subroutine 116 of the embodiment 100 can next receive the requested credit bureau data and the data in volatile memory, for instance.

A potential eligibility subroutine 118 of the embodiment 100 can use a processor of the embodiment 100 to compare an income predictor parameter of the received credit bureau data and the guarantor's number of dependents to data in a look-up table similar to Table 3. Thus, the embodiment can determine whether the guarantor's data falls within the constraints of the look-up table. Accordingly, the potential eligibility subroutine 118 can return information such as (1) whether the income predictor and number of dependents satisfy any range(s) of the look-up table, i.e. whether the corresponding guarantor is potentially eligible for a write-off, and (2) the percentage write-off to which the corresponding guarantor may be entitled provided all other conditions are met. Alternatively, in some embodiments zero percent write-offs can be within the constraints of the look-up table.

Next a disqualifier subroutine 120 of the embodiment 100 can use a processor of the embodiment 100 to compare selected credit bureau data fields such as the Open Auto, Open To Buy, and Mortgage parameters to predetermined maxima. If none of the maxima are exceeded then the guarantor is eligible for the charitable write-off determined by the potential eligibility subroutine 118. However, if any one of the maxima is met and/or exceeded then the disqualifier subroutine returns data indicating that the guarantor is disqualified from charitable write-offs 122.

If the guarantor is disqualified by the disqualifier subroutine 120 then the collection subroutine 124 can determine whether the guarantor is likely to be eligible for financial assistance from MedicAid 110, and bill MedicAid if appropriate 126. Otherwise, the collection subroutine 124 can assign a debt collection protocol to the guarantor according to the guarantor's likelihood of paying and the magnitude of the debt. Particularly, the collection protocol 124 calculates a PPI according to Formula 1, and the debt magnitude is categorized as either “high” or “low” according to predetermined limits. According to some embodiments the specific limits of the high and low debt categories are assigned and/or reassigned by a user of the embodiment according to specific business needs. For instance, a low debt magnitude may be from zero to $3000 and a high debt magnitude may be any amount over $3000. Alternatively, some embodiments may take other parameters into account when categorizing a debt magnitude as high or low. For instance, such factors may include the guarantor's income, the aggregate amount of the guarantor's other debts, etc. Furthermore, some embodiment may include additional debt magnitude categories.

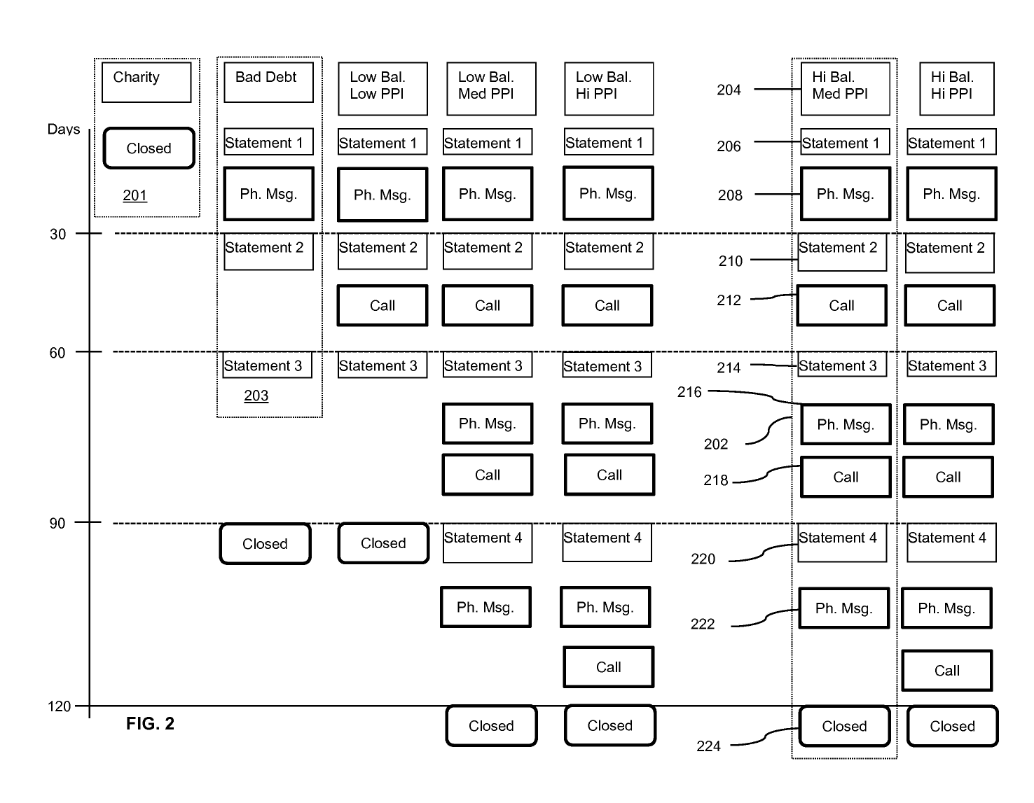

FIG. 2 is a schematic drawing of an embodiment comprising a set of communications protocols 200 categorized according to PPI and debt magnitude. For instance a communications protocol 202 specifically optimized for guarantors having a high debt balance and medium PPI can include providing a first billing statement and cover letter 206 to the guarantor. If the guarantor's account continues to have a positive balance after a first prescribed period of time, e.g. 15 days from the billing statement date, then the statement 206 may be followed up with an automated telephone message 208. If the guarantor's balance is greater than zero at 30 days, then a second statement can be issued to the guarantor with a second cover letter 210. If the guarantor's account continues to have a positive balance after a second prescribed period of time, e.g. 15 days from the date of the second billing statement date, then a live telephone call can be made to the guarantor requesting payment 212. Continuing the example, if the guarantor's balance is greater than zero at 60 days then a third statement and cover letter 214 can be provided to the guarantor requesting payment. If the guarantor's account continues to have a positive balance after a prescribed period of time, e.g. 15 days from the third statement date, then an automated telephone message can be provided to the guarantor 216. Furthermore, the automated telephone message 216 can be followed up with a live telephone call 218 requesting payment. If the guarantor still has a positive balance at 90 days then a fourth and final statement can be provided with a cover letter 220. If the guarantor's account continues to have a positive balance after a fourth prescribed period of time, e.g. 15 days from the fourth statement date, then an automated telephone message can be provided to the guarantor requesting payment. Finally, according this example, if the guarantor's account continues to have a positive balance after 120 days then the account can be closed 224 and the debt can be written off as bad debt.

According to some embodiments of the invention, a guarantor with a high balance and a high PPI may warrant dedicating greater resources to collection, whereas a guarantor with a low balance and a low PPI may warrant dedicating fewer resources. Furthermore, accounts that are classified as charity or qualify for assistance may warrant a collections protocol 201 comprising immediately closing the account and writing off the debt. Still further, accounts that have been categorized as bad debt may still warrant a limited collections protocol 203.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

1. A computerized data stratification and correspondence generation process, comprising the steps of:
loading a guarantor's health care billing data including at least a Total Charges parameter, a number of the guarantor's dependents, and at least one identifying datum into a random access memory;
executing a new accounts subroutine, wherein a processor searches a guarantor database using the at least one identifying datum for a record of the guarantor and determines whether the guarantor is a new or existing guarantor;
executing a credit data request subroutine, wherein the processor retrieves credit bureau data of the guarantor, the credit bureau data including an income predictor, an Open Auto parameter, a Mortgage parameter, an Open To Buy parameter, an HCPI, and a Derogatories parameter, and the processor loading the credit bureau data into a random access memory;
executing a potential eligibility subroutine, wherein the processor relates a combination of the guarantor's income predictor and number of dependents to a percentage write-off, the potential eligibility subroutine returning a percentage write-off;
executing a disqualifier subroutine, wherein the processor compares the guarantor's Open Auto, Open To Buy and Mortgage parameters to predetermined maxima, the disqualifier subroutine returning a determination of whether or not the guarantor has exceeded one or more of the predetermined maxima;
executing a payment probability indicator subroutine, wherein the processor calculates a payment probability indicator by taking the sum of the guarantor's HCPI, and HCPI adjustment amounts related to the guarantor's Derogatories, Open To Buy and Total Charges parameters, the payment probability indicator subroutine returning the payment probability indicator; and
executing a collection subroutine, wherein the processor selects a collections protocol according to the payment probability indicator and a debt magnitude of the guarantor, the collections subroutine issuing at least a first billing statement and cover letter according to the selected protocol.

2. The process of claim 1, wherein the step of loading a guarantor's health care billing data further comprises receiving the health care billing data from an external accounts receivable database.

3. The process of claim 1, wherein the step of executing a new accounts subroutine further comprises performing an action with the healthcare billing data selected from one or more of updating the corresponding guarantor database record, correcting the corresponding guarantor database record, adding missing guarantor data to the corresponding guarantor database record, or creating a new guarantor database record for the guarantor if none already exists in the guarantor database.

4. The process of claim 1, wherein the step of executing a credit data request subroutine further comprises retrieving the credit bureau data either from a remote credit bureau database or from a local database.

5. The process of claim 1, further comprising manually adding or updating guarantor credit data.

6. The process of claim 1, wherein the income predictor comprises the sum of the guarantor's income predictor and the income predictor of the guarantor's spouse if any.

7. The process of claim 1, wherein the step of executing a potential eligibility subroutine further comprises providing a look-up table relating one or more combinations of income predictor and number of dependents to percentage write-offs, and the processor matching the guarantor's income predictor and number of dependents to a percentage write-off.

8. The process of claim 1, wherein the step of executing a disqualifier subroutine includes indicating whether the guarantor is disqualified from write-off eligibility.

9. The process of claim 1, further comprising providing a look-up table relating ranges of each of the Derogatories, Open To Buy and Total Charges parameters to corresponding HCPI adjustment amounts.

10. The process of claim 1, wherein the processor assigns the payment probability indictor to a payment risk category, and the processor assigns a debt of the guarantor to a debt magnitude category, and the processor selects a collections protocol from a set of predetermined collections protocols corresponding to a combination of the of the payment risk category and the debt magnitude category, the collections subroutine returning the selected collections protocol, and issuing at least a first billing statement and cover letter according to the selected protocol.

11. The process of claim 1, wherein the payment probability indicator is manually determined and entered into the system.

12. The process of claim 1, further comprising assessing the guarantor's eligibility for Medicaid assistance, and billing Medicaid for the guarantor's debt.

13. A computerized process for determining a payment probability indicator, comprising the steps of:
using a processor to retrieve a guarantor's income predictor, number of dependents, Open Auto, Mortgage, Open To Buy, HCPI, Derogatories, and Total Charges from a plurality of data sources;
the processor taking the sum of the guarantor's HCPI and HCPI adjustment amounts related to the guarantor's Derogatories, Open To Buy and Total Charges parameters, the payment probability indicator subroutine returning the payment probability indicator.

14. The process of claim 13, wherein the income predictor comprises the sum of the guarantor's income predictor and the income predictor of the guarantor's spouse.

15. The process of claim 13, further comprising providing a look-up table relating ranges of each of the Derogatories, Open To Buy and Total Charges parameters to corresponding HCPI adjustment amounts.

16. A computerized data stratification and correspondence generation process, comprising the steps of:
loading a guarantor's health care billing data including a number of the guarantor's dependents, a Total Charges parameter, and at least one identifying datum into a random access memory;
executing a new accounts subroutine, wherein a processor searches a guarantor database using the at least one identifying datum for a record of the guarantor and performing an action with the healthcare billing data selected from one or more of updating the corresponding guarantor database record, correcting the corresponding guarantor database record, adding missing guarantor data to the corresponding guarantor database record, or creating a new guarantor database record for the guarantor if none already exists in the guarantor database;
executing a credit bureau data request subroutine, wherein the processor retrieves credit bureau data of the guarantor from a remote credit bureau database, the credit bureau data including an income predictor, an Open Auto parameter, a Mortgage parameter, an Open To Buy parameter, an HCPI, and a Derogatories parameter, and the processor loading the credit bureau data into a random access memory;
executing a potential eligibility subroutine, wherein the processor relates a combination of the guarantor's income predictor and number of dependents to a percentage write-off, the potential eligibility subroutine returning a percentage write-off;
executing a disqualifier subroutine, wherein the processor compares the guarantor's Open Auto, Open To Buy and Mortgage parameters to predetermined maxima, the disqualifier subroutine returning a determination of whether the guarantor is disqualified from eligibility for a write-off for exceeding one or more of the predetermined maxima;
executing a payment probability indicator subroutine, wherein the processor relates each of the Derogatories, Open To Buy and Total Charges parameters to corresponding HCPI adjustment amounts, adds the corresponding HCPI adjustment amounts to the HCPI, and returns the corresponding payment probability indicator; and
executing a collection subroutine, wherein the processor assigns the payment probability indicator to a payment risk category, and the processor assigns a debt of the guarantor to a debt magnitude category, and the processor selects a collections protocol from a set of predetermined collections protocols corresponding to a combination of the of the payment risk category and the debt magnitude category, the collections subroutine returning the selected collections protocol, and issuing at least a first billing statement and cover letter according to the selected protocol.

17. The process of claim 16, further comprising manually adding or updating guarantor credit data.

18. The process of claim 16, wherein the payment probability indicator is manually determined and entered into the system.

19. The process of claim 16, further comprising determining whether the guarantor is eligible for Medicaid assistance, and billing Medicaid for the guarantor's debt.
